(19) United States
(12) Patent Application Publication
(10) Pub. No.: US 2004/0233170 A1
(43) Pub. Date: Nov. 25, 2004

(54) Image navigation module for optical mouse

(76) Inventor: Dong-Hoon Kang, Seoul (KR)

Correspondence Address: GOTTLIEB RACKMAN & REISMAN PC, 270 MADISON AVENUE, 8TH FLOOR, NEW YORK, NY, 100160601

(21) Appl. No.: 10/802,478

(22) Filed: Mar. 16, 2004

(30) Foreign Application Priority Data
Apr. 15, 2003 (KR) 2003-23750

(51) Int. Cl. G09G 5/08

(52) U.S. Cl. 345/166

(57) ABSTRACT

Disclosed herein is an image navigation module for an optical mouse. The image navigation module includes a module unit and a lid type prism-integrated lens. The module unit is constructed in such a way that a light emitting element and a sensor die are constructed on a board in a chip-on board manner. The lid type prism-integrated lens is put on the board to cover regions where the light emitting element and the sensor die are constructed. The sensor die is a single chip sensor into which an image sensor for detecting light converged by the lid type prism-integrated lens and a Main Control Unit (MCU) for processing detected signals are integrated.

### BACKGROUND OF THE INVENTION

1. Field of the Invention

The present invention relates generally to an image navigation module for an optical mouse and, more particularly, to an image navigation module for an optical mouse, in which an image navigation mechanism is modularized by constructing a sensor die, into which an image sensor and a main control unit are integrated, and a light emitting diode on a printed circuit board in a chip-on board manner, and combining a small-sized lens with the printed circuit board with the sensor die and light emitting diode constructed thereon, thus improving the performance of the optical mouse by increasing the sensing efficiency of the image navigation mechanism, and reducing the manufacturing costs of the optical mouse.

2. Description of the Related Art

A mouse, which is one of the input means for computers, is a device that is used to directly or indirectly instruct a computer on the coordinates of a cursor or pointer. Such mice are classified into two types; ball mice that each inputs the moving direction and distance of the mouse by utilizing the rotation of a ball, and optical mice that each detect the moving direction and distance of the mouse by tracing the movement of the images of a contact surface formed by light irradiated from a mouse body.

A conventional ball mouse adopts a scheme of representing coordinates on a screen in such a way that sensors located in a mouse body detect the rotation of a ball when the ball is rotated while being in contact with the surface of a mouse pad or the like, and dissolve detected signals into two perpendicular components.

The conventional ball mouse is inconvenient in that the ball of the mouse is rotated while being in contact with a contact surface, so that contaminants easily adhere to the ball, and the contaminants adhering to the ball has a deleterious effect on the operation of the mouse and, thereby, hinders the operation of the mouse, thus requiring periodical cleaning of the mouse.

In contrast, a conventional optical mouse adopts a scheme of detecting the direction and distance of movement of the mouse in such a way that the images of a contact surface are formed by allowing the contact surface to reflect light irradiated from the body of the mouse, the images are continuously and quickly captured, and the captured images are sequentially compared, rather than in such a way that the movement of a ball is mechanically detected. This scheme is implemented by representing the position of a cursor in such a way as to optically recognize the movement of an object in contact with the mouse, to generate recognized values in the form of electrical signals and to transmit the electrical signals to a computer.

The operation and structure of such a convention optical mouse are well known, descriptions of which are omitted in the present specification.

Since the conventional optical mouse has various advantages compared with the conventional ball mouse in that the movement of the mouse is accurately detected and is smoothly conducted, the use of the mouse tends to be increasing currently.

FIG. 1 is a perspective view showing the bottom of the conventional optical mouse. The conventional optical mouse 1 has a base plate 2 in which an opening 3 is formed at the center portion thereof. The optical mouse 1 can observe the surface of an object (mouse pad or the like), with which the optical mouse 1 makes contact, through the opening 3, and signals (X and Y coordinates) detected by the optical mouse 1 are transmitted to a computer (not shown) through a cable 4.

An image navigation mechanism for detecting signals (X and Y coordinates) in the conventional optical mouse is shown in FIG. 2. Referring to FIG. 2, the image navigation mechanism for the conventional optical mouse is described below. The general optical system of a general optical mouse is constructed to include a Light Emitting Diode (LED) 11 for irradiating light, a lens 12 for converging light irradiated from the LED 11 and reflected by the surface 10 of a mouse pad, an image sensor 13 for detecting light converged by the lens 12, a Main Control Unit (MCU, not shown) for performing signal processing and control, and a Printed Circuit Board (PCB) 15 on which the image sensor 13 is mounted.

The LED 11 is secured by an LED holder 14. The LED holder 14 is provided with an opening 14a to pass light therethrough so that light irradiated from the LED 11 is reflected by the surface 10 of the mouse pad.

The lens 12 includes a reflection surface 12a for first reflecting light irradiated from the LED 11, a second reflection surface 12b for second reflecting the light reflected by the reflection surface 12a, and a lens surface 12c for converging the light reflected by the second reflection surface 12b, passed through the opening 3 of the base plate 2 and reflected by the surface 10 of the mouse pad.

The lens 12 is placed in such a way that the lens 12c is located above the opening 3 of the base plate 2 of the optical mouse.

The lens surface 12c functions to converge light reflected by the surface 10 so that the light is focused. The image sensor 13 is located immediately above the lens surface 12c so that the light converged by the lens surface 12c is transferred to the image sensor 13 and detected by the image sensor 13.

The image sensor 13 includes a circuit (algorithm) for capturing the images of the surface 10 on which the optical mouse slides, and analyzing the captured images.

The LED 11 and the image sensor 13 are mounted on the PCB 15, and the PCB 15 is mounted on the lens 12.

The conventional image navigation mechanism of the optical mouse having the above-described structure is described below.

The LED 11 irradiates light.

At this time, the light is irradiated through the opening 14a of the LED holder 14, and the light irradiated from the LED 11 is directed toward the reflection surface 12a of the lens 12 and then reflected by the surface 12a.

The light reflected by the reflection surface 12a is directed toward and reflected by the second reflection surface 12b.

The light reflected by the second reflection surface 12b is passed through the opening 3 of the base plate 2, and is brought into contact with and reflected by the surface 10.

The light reflected by the contact surface 10 is converged by the lens surface 12c and then is incident on the image sensor 13.

The image sensor 13 continuously captures images using the light reflected by the surface 10, and the moving direction and magnitude of the optical mouse are recognized through the analysis of the captured images. The recognized values are converted into electrical signals and the converted electrical signals are transmitted to a computer.

Accordingly, the image sensor 13 interprets the captured images and transfers the X and Y coordinates of a cursor on a screen.

In the conventional optical mouse, the LED 11, the lens 12, the image sensor 13 and the MCU constituting the image navigation mechanism are formed of discrete parts, respectively, and the optical system of the optical mouse is formed by mounting the discrete parts on the PCB 13, so that the following problems arise.

The discrete parts are assembled into the optical system, so that the performance of the optical mouse is degraded due to the assembly deviation of the discrete parts and, thus, a sensing error occurs, thus causing the performance deviation of the optical mouse to be increased.

Additionally, the discrete parts are manually assembled into the optical mouse, so that assembly work is ineffective, the working efficiency of a worker is low and assembly time is lengthened.

The number of component parts is large, so that the manufacturing costs of the optical mouse are increased, which requires an improvement in the number of component parts.

### SUMMARY OF THE INVENTION

Accordingly, the present invention has been made keeping in mind the above problems occurring in the prior art, and an object of the present invention is to provide an image navigation module for an optical mouse, which is modularized by constructing a sensor die, into which an image sensor for recognizing light reflected by a contact surface and an MCU are integrated, and a chip LED on a PCB in a Chip-On Board (COB) manner and adopting a small-sized prism-integrated lens, so the performance and assembly deviations of component parts are reduced, thus improving the performance of the optical mouse.

Another object of the present invention is to provide an image navigation module for an optical mouse, which adopts a modularized component part, so that the efficiency of assembly work is improved, the working efficiency of a worker is improved, and the manufacturing time is considerably reduced.

Still another object of the present invention is to provide an image navigation module for an optical mouse, which allows the number of component parts to be reduced, thus curtailing the manufacturing costs of the optical mouse.

In order to accomplish the above object, the present invention provides an image navigation module for an optical mouse, comprising a module unit in which a light emitting element and a sensor die are constructed on a board in a chip-on board manner; and a lid type prism-integrated lens put on the board to cover regions where the light emitting element and the sensor die are constructed.

The sensor die may be a single chip sensor into which an image sensor for detecting light converged by the lid type prism-integrated lens and a Main Control Unit (MCU) for processing detected signals are integrated, and the lid type prism-integrated lens may include a first lens surface for converging light irradiated from the light emitting element, a reflection surface for reflecting the converged light, and a second lens surface for converging light.

The sensor die and the light emitting element may be formed on the lower surface of the board, the reflection surface and first lens surface of the lid type prism-integrated lens may be formed to be located below the light emitting element, and the second lens surface may be formed to be located below the sensor die.

The reflection surface may be formed to be inclined at an angle that is capable of reflecting the light irradiated from the light emitting element toward a contact surface outside of the optical mouse.

The image navigation module may further comprise a light interception plate located between the light emitting element and the sensor die to prevent the light irradiated from the light emitting element from being directly incident on the sensor die.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing the bottom of a conventional optical mouse;

FIG. 2 is a cross section showing the image navigation mechanism of the conventional optical mouse;

FIG. 3 is an exploded perspective view showing an image navigation module for an optical mouse in accordance with an embodiment of the present invention; and

FIG. 4 is a cross section of the image navigation module of FIG. 3.

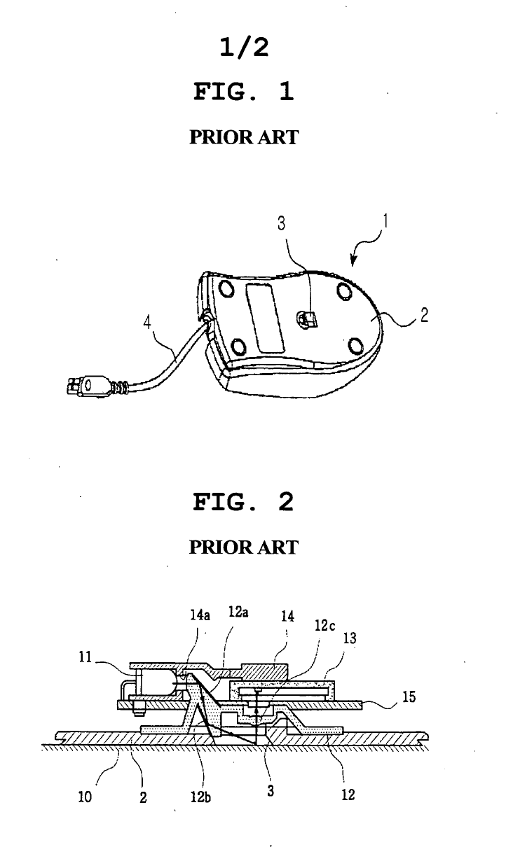

### DESCRIPTION OF THE PREFERRED EMBODIMENTS

Reference now should be made to the drawings, in which the same reference numerals are used throughout the different drawings to designate the same or similar components.

An image navigation module for an optical mouse according to an embodiment of the present invention is described in detail with reference to the attached drawings.

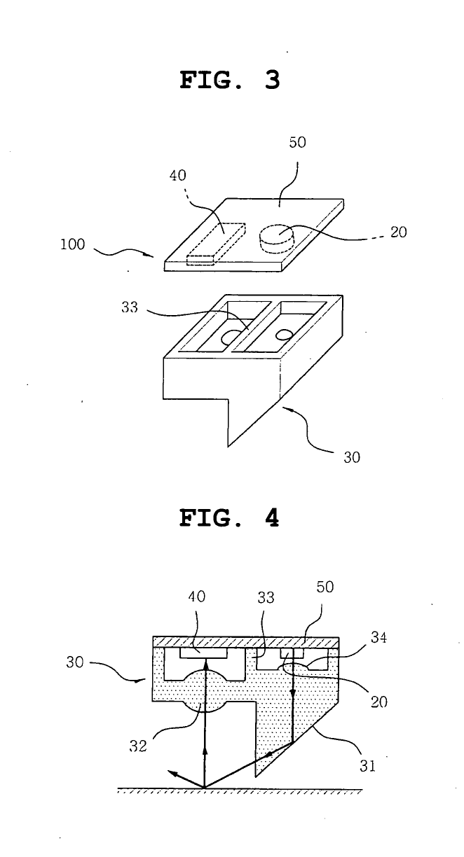

FIG. 3 is an exploded perspective view showing the image navigation module for an optical mouse according to the embodiment of the present invention. FIG. 4 is a cross section of the image navigation module of FIG. 3.

As shown in the drawings, the image navigation module for the optical mouse according to the embodiment of the present invention includes a light emitting element 20 for irradiating light, a single-body lens 30 for reflecting light irradiated from the light emitting element 20 to shine on an object with which the optical mouse makes contact, and converging light reflected by the surface of the object, a sensor die 40 for detecting the light converged by the single-body lens 30 and processing detected signals, and a board 50 on which the sensor die 40 is mounted.

The light emitting element 20 is an LED, and includes a CHIP-type or DIP-type LED. The light emitting element 20 is constructed on the board 50 in a COB or DIP manner.

The sensor die 40 is a single chip sensor in which an image sensor for detecting light converged by the lens 30 is integrated with a MCU for processing the detected signals. The sensor die 40 is constructed in a COB manner, like the light emitting element 20.

As a result, an image navigation module 100 is formed by mounting the light emitting element 20 and the sensor die 40 on the board 50 in a COB manner.

The present invention in which the light emitting element 20 and the sensor die 40 are constructed on the board 50 in the COB manner can modularize the image navigation mechanism.

Accordingly, compared with the prior art image navigation mechanism in which the ELD, that is, a light source, is mounted on the PCB while being secured in the ELD holder and the image sensor and the EMU are separately mounted on the PCB, the present invention allows the sensor die 40 and the light emitting element 20 having chip forms to be directly constructed on the board in a chip-on board manner, so that the volume of the image navigation mechanism can be considerably reduced.

As a result, the image navigation mechanism can be miniaturized.

In the prior art, discrete parts are manually mounted on the PCB, so that assembly work is inconvenient and the efficiency of assembly work is low. In the present invention, the modularized board 50 is handled without a need for handling discrete parts. Accordingly, the handling of discrete parts is facilitated and the manufacturing process of the image navigation mechanism is simplified, thereby improving the efficiency of the manufacturing work.

In the meantime, the single body lens 30 is formed of a lid type prism-integrated lens to cover regions where the light emitting element 20 and the sensor die 40 are mounted.

The single-body lens 30 includes a first lens surface 34 for converging light irradiated from the light emitting element, a reflection surface 31 for reflecting the converged light, and a second lens 32 for converging the light reflected by the reflection surface 31.

The reflection surface 31 functions to primarily reflect the light irradiated from the light emitting element 20, and the second lens surface 32 functions to converge light reflected by the object with which the optical mouse makes contact, so as to focus the light.

In the meantime, the sensor die 40 and the light emitting element are formed on the lower surface of the board 50 so that the light emitting element 20 irradiates light downwardly.

Accordingly, the first lens surface 34 and reflection surface 31 of the single body lens 30 are formed to be located below the light emitting element 20 so that light irradiated from the light emitting element 20 is converged and then reflected. The second lens surface 32 of the single body lens 30 is formed to be located below the sensor die 40 so that light reflected by the object with which the optical mouse makes contact is converged and then is incident on the sensor die 40.

In this case, the reflection surface 31 is formed to be inclined at an angle capable of reflect light irradiated from the light emitting element 20 out of the optical mouse.

As a result, in the present invention, the single body lens 30 can have the single reflection surface 31 and the light reflected from the light emitting element 20 is reflected only by the single reflection surface 31, so that the brightness of the light is increased and the sensing efficiency of the optical mouse is increased. Accordingly, the light can reach the object (mouse pad) with which the optical mouse makes contact, and light reflected by the surface of the object can be incident on the sensor die 40 through the second reflection surface 32.

The single body lens 30 has the single reflection surface 31 and covers the board 50 in the form of a lid, so that the size of the single body lens 30 is considerably small compared with the conventional lens, thus enabling the miniaturization of the lens.

In this case, the single body lens 30 is mounted so that the second lens surface 32 of the single body lens 30 is located above the opening of the base plate (not shown) of the optical mouse.

Furthermore, a partition wall 33 is formed to separate regions where the light emitting element 20 and the sensor die 40 are mounted, from each other.

The partition wall 33 functions to prevent the light irradiated from the light emitting element 20 from being directly incident on the sensor die 40 as well as to separate the mounted regions.

To further secure the interception of the light, a light intercepting plate (not shown) may be additionally located between the light emitting element 20 and the sensor die 40 to prevent the light irradiated from the light emitting element 20 from being directly incident on the sensor die 40.

Structures for preventing the light irradiated from the light emitting element 20 from being directly incident on the sensor die 40 may be implemented in various ways. Consequently, the present invention is not limited to the structures described above.

The operation of the image navigation module for the optical mouse constructed as described above is described below.

Light is irradiated from the light emitting element 20.

The light irradiated from the light emitting element 20 is converged by the first lens surface 34 of the single body lens 30, is directed toward the reflection surface 31, and then is reflected by the reflection surface 31.

At this time, the reflection surface 31 is inclined at an angle capable of reflecting the light irradiated from the light emitting element 20 toward the surface of the object outside of the optical mouse, so that the light reflected by the reflecting surface 31 can pass through the opening of the base plate, comes in contact with the surface of the object and is reflected by the surface of the object.

The light reflected by the surface is converged by the second lens surface 32 and, thereafter, is incident on the sensor die 40 into which the image sensor and the MCU are integrated.

The sensor die 40 continuously captures images formed by the light reflected by the surface of the object, interprets the captured images and, thus, recognizes the direction and magnitude of the movement of the optical mouse. The recognized values are converted into electrical signals, and the converted electrical signals are transferred to a computer.

In brief, the sensor die 40 interprets the images of the surface and transmits the X and Y coordinates of a cursor on a monitor.

In the embodiment of the present invention, the image navigation module is modularized, so that the performance and assembly deviations of component parts can be reduced, thus improving the performance of the optical mouse.

As described above, the present invention provides an image navigation module for an optical mouse, in which an image navigation mechanism is modularized by constructing the sensor die, into which the image sensor for recognizing light reflected by the contact surface outside of the optical mouse and the MCU are integrated, and the light emitting element on the PCB in an chip-on board manner and adopting the small-sized prism-integrated lens, thus reducing the performance and assembly deviations of component parts and, thus, improving the performance of the optical mouse.

Furthermore, the modularized component is employed, so that the efficiency of assembly work can be increased, the work efficiency of a worker can be improved, and assembly time can be reduced.

Furthermore, in the prior art, the sensor, the MCU, the lens and the LED are separately manufactured, thus incurring high manufacturing costs. In the present invention, the image navigation mechanism is modularized, so that the number of component parts is reduced, thereby curtailing the manufacturing costs of the optical mouse.

Furthermore, while the image navigation module being is manufactured, light axes can be aligned and the optimization of the images of contact surfaces can be implemented, so the sensing efficiency of the optical mouse can be maximized.

Furthermore, only the modularized board and a single part to be packaged together with the modularized board are handled without a need of handling discrete parts, so that part handling and a manufacturing procedure are simplified, thereby improving the efficiency of manufacturing and realizing the additional curtailment of manufacturing costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image navigation module for an optical mouse, comprising:
a module unit in which a light emitting element and a sensor die are constructed on a board in a chip-on board manner; and
a lid type prism-integrated lens put on the board to cover regions where the light emitting element and the sensor die are constructed.

2. The image navigation module as set forth in claim 1, wherein the sensor die is a single chip sensor into which an image sensor for detecting light converged by the lid type prism-integrated lens and a Main Control Unit (MCU) for processing detected signals are integrated.

3. The image navigation module as set forth in claim 1, wherein the lid type prism-integrated lens includes a first lens surface for converging light irradiated from the light emitting element, a reflection surface for reflecting the converged light, and a second lens surface for converging light.

4. The image navigation module as set forth in claim 3, wherein the sensor die and the light emitting element are formed on a lower surface of the board, the reflection surface and first lens surface of the lid type prism-integrated lens are formed to be located below the light emitting element, and the second lens surface is formed to be located below the sensor die.

5. The image navigation module as set forth in claim 4, wherein the reflection surface is formed to be inclined at an angle that is capable of reflecting the light irradiated from the light emitting element toward a contact surface outside of the optical mouse.

6. The image navigation module as set forth in claim 3, further comprising a light interception plate located between the light emitting element and the sensor die to prevent the light irradiated from the light emitting element from being directly incident on the sensor die.

7. An optical mouse having an image navigation module, the image navigation module comprising:
a module unit in which a light emitting element and a sensor die are constructed on a board in a chip-on board manner; and
a lid type prism-integrated lens put on the board to cover regions where the light emitting element and the sensor die are constructed.
